(19) United States
(12) Patent Application Publication
(10) Pub. No.: US 2013/0088146 A1
(43) Pub. Date: Apr. 11, 2013

(54) INDUCTIVELY COUPLED PLASMA GENERATION DEVICE

(71) Applicants: Ryuichi Matsuda, Tokyo (JP); Seiji Nishikawa, Tokyo (JP)

(72) Inventors: Ryuichi Matsuda, Tokyo (JP); Seiji Nishikawa, Tokyo (JP)

(73) Assignee: MITSUBISHI HEAVY INDUSTRIES, LTD., Tokyo (JP)

(21) Appl. No.: 13/695,566

(22) PCT Filed: Jun. 13, 2011
(86) PCT No.: PCT/JP2011/063539

§ 371 Date: Dec. 21, 2012

(30) Foreign Application Priority Data
Jun. 18, 2010 (JP) 2010-138973

(51) Int. Cl. H05H 1/00

(52) U.S. Cl. CPC H05H 1/00
USPC 315/34

(57) ABSTRACT

Provided is an inductively coupled plasma generation device capable of having both a wide matching range and reduced loss. An inductively coupled plasma generation device in which high harmonic waves from a high harmonic wave power source (11) are supplied to an antenna (14) by way of a matching device (12) which matches impedance, and plasma is generated in a vacuum vessel by electromagnetic waves from the antenna (14), wherein an L-type matching circuit is used as the matching device (12) and a capacitor (C3) is provided parallel to the antenna (14) at a position closer to the antenna (14) than capacitors (C1, C2) in the L-type matching circuit.

### TECHNICAL FIELD

The present invention relates to an inductively coupled plasma generation device for generating plasma in a vacuum chamber.

### BACKGROUND ART

In some semiconductor device fabrication, thin film formation, etching, or the like is done by performing plasma processing on a disk-shaped substrate (wafer). Among devices therefor, plasma generation devices of an inductively coupled plasma (ICP) type configured to supply an electromagnetic wave through inductive coupling are known as efficient plasma generation devices for their ability to generate high-density plasma.

### PRIOR ART DOCUMENT

### Patent Document

Patent Document 1: Japanese Patent Application Publication No. 2006-221852

### SUMMARY OF THE INVENTION

### Problem to be Solved by the Invention

FIG. 10 shows the circuit configuration of a conventional ICP-type plasma generation device. In the ICP-type plasma generation device, a high-frequency power source 51 is represented as an RF power source PS (for example, a frequency of 13.56 MHz) and an internal resistance R (50Ω), and an antenna 54 of an antenna unit 53 is represented as a coil. The high-frequency power source 51 is connected to the antenna unit 53 through a matching box 52 configured to perform impedance matching. As the matching box 52, a matching box having what is called an L-type matching circuit is used in which a pre-set coil L1 and a variable capacitor C1, and a pre-set coil L2 and a variable capacitor C2 are disposed in an L shape.

With the configuration as above, an electromagnetic wave is supplied from the antenna 54 into a vacuum chamber of a plasma processing apparatus to generate plasma in the vacuum chamber. An electrical plasma load 55 of the generated plasma can be understood as transformer coupling in which the antenna 54 serves as a primary winding and the plasma serves as a secondary winding formed of a coil and a resistance.

Conventional ICP-type plasma generation devices have been using the matching box 52 having the L-type matching circuit which is capable of ensuring a wide matching range, in order to be able to generate plasma regardless of the antenna shape and the plasma processing conditions. For example, in the case of the circuit configuration shown in FIG. 10, a matching range A1 which is adjustable and a matching range A2 which covers antenna shapes and plasma processing conditions appear as ranges as shown in Part (a) of FIG. 11 when illustrated by using a Smith chart which is used for calculating impedance matching. In a case of a range as shown by the matching range A2, that matching range is considered sufficiently wide, so that the matching box 52 can be used regardless of the antenna shape and the plasma processing conditions (such as the type of gas and the pressure). For this reason, there is no need to prepare various types of matching boxes. Thus, managing the models of the device is easy.

Meanwhile, in a case of a circuit configuration as shown in FIG. 10, high current flows in the coils L1 and L2 if the impedance (load impedance) of the antenna 54 and the plasma load 55 downstream of the matching box 52 is small. This increases the Joule heat generated by the pure resistance of the coils L1 and L2, which in turn results in a large loss in inputted power. In recent years, processing targets, or circular substrates, have been becoming increasingly larger. As the substrate becomes larger, the coils and transmission lines require greater cooling. For this reason, it has been desired to reduce the loss in inputted power.

If the coils L1 and L2 are not in the matching box 52, the very sources of the Joule heat are eliminated. Thus, it is possible to reduce the loss in inputted power. In this case, however, a matching range A3 which is adjustable and a matching range A4 which covers antenna shapes appear as shown in Part (b) of FIG. 11 when illustrated by using a Smith chart; the matching range A4 is extremely narrow. This means that the capacitance of each of the capacitors C1 and C2 needs to be adjusted on an antenna-shape basis. For this reason, various types of matching boxes need to be prepared on an antenna-shape basis. Thus, managing the models of the device in stock is not easy. The matching range A4 which covers antenna shapes further imposes a limitation on the matching range for plasma processing conditions, as a matter of course.

For the above reasons, the conventional ICP-type plasma generation devices have had a problem in achieving both a wide matching range and a reduced power loss.

Now, a difference between the present invention and Patent Document 1 similar thereto should be mentioned. Patent Document 1 shows a configuration in which a capacitor is connected in parallel to at least one of two or more antennae connected in series. This aims to adjust the ratio of high-frequency currents flowing in the two or more antennae by means of the capacitor connected thereto. With this configuration, the evenness of the plasma density is improved (see paragraphs 0015, 0016, 0024, and the like of Patent Document 1). This differs completely from the present invention described later in terms of the object as well as operations and effects.

The present invention has been made in view of the above problem, and an object thereof is to provide an inductively coupled plasma generation device capable of achieving both a wide matching range and a reduced power loss.

### Means for Solving the Problems

An inductively coupled plasma generation device according to a first aspect of the invention for solving the above problem is an inductively coupled plasma generation device for generating plasma in a vacuum chamber by use of an electromagnetic wave from an antenna obtained by supplying a high-frequency wave from a high-frequency power source to the antenna through a matching box configured to perform impedance matching, wherein

an L-type matching circuit is used as the matching box, and

another capacitor is provided parallel to the antenna at a position closer to the antenna than capacitors in the L-type matching circuit.

The inductively coupled plasma generation device according to a second aspect of the invention for solving the above problem is that wherein in the inductively coupled plasma generation device described in the first aspect of the invention, a commercially available capacitor is used as said another capacitor.

The inductively coupled plasma generation device according to a third aspect of the invention for solving the above problem is that wherein in the inductively coupled plasma generation device described in the first aspect of the invention, a circumference of the antenna is surrounded by a grounded cylindrical housing while a cylindrical member coaxial with the housing is provided to a transmission line on a higher voltage side connected to the antenna, to thereby form a coaxial capacitor with the housing and the cylindrical member, and

the coaxial capacitor is used as said another capacitor.

The inductively coupled plasma generation device according to a fourth aspect of the invention for solving the above problem is that wherein in the inductively coupled plasma generation device described in the first aspect of the invention, a cylindrical member with a center axis thereof being set on a transmission line on a higher voltage side connected to the antenna is provided to a transmission line on a ground side connected to the antenna, to thereby form a coaxial capacitor with the transmission line on the higher voltage side and the cylindrical member, and

the coaxial capacitor is used as said another capacitor.

The inductively coupled plasma generation device according to a fifth aspect of the invention for solving the above problem is that wherein in the inductively coupled plasma generation device described in the first aspect of the invention, a grounded plate member is provided above the antenna while another plate member parallel to the plate member is provided to a transmission line on a higher voltage side connected to the antenna, to thereby form a plate capacitor with the plate member and said another plate member, and

the plate capacitor is used as said another capacitor.

The inductively coupled plasma generation device according to a sixth aspect of the invention for solving the above problem is that wherein in the inductively coupled plasma generation device described in the fifth aspect of the invention, the antenna is formed of a plurality of antennae of different sizes connected to each other in parallel, and

the plurality of antennae are disposed concentric to each other on a same plane.

### Effects of the Invention

According to the first aspect of the invention, even when an L-type matching circuit is used as the matching box, said another capacitor provided in the vicinity of the antenna can reduce the amount of current flowing in the coils in the L-type matching circuit. This reduces the generation of Joule heat in the coils. Thereby, it is possible to suppress a loss in inputted power. Since the matching box having the L-type matching circuit combining sets of a coil and a capacitor has a sufficiently wide matching range. Accordingly, it is possible to achieve both a wide matching range and a reduced power loss. Moreover, since the amount of current flowing in each coil in the L-type matching circuit is reduced, one can select a capacitor with low rated current and withstand voltage for each capacitor in the L-type matching circuit. Accordingly, it is possible to reduce the size and cost of the matching box. Furthermore, since the generation of the Joule heat in each coil is reduced, the cooling mechanism of the matching box can be made an air-cooling type, thereby allowing simplification of the structure thereof. Accordingly, it is possible to further reduce the cost.

According to the second aspect of the invention, a commercially available capacitor is used as said another capacitor. Accordingly, modification of conventional devices is done easily.

According to the third to sixth aspects of the invention, like the first invention, a wide matching range and a reduced power loss can both be achieved. Accordingly, it is possible to reduce the size and cost of the matching box.

In addition, according to the third to sixth aspects of the invention, each of the cylindrical members provided to the transmission lines on the higher voltage side and the ground side, and each of the plate member and said another plate member provided to the transmission lines on the ground side and the higher voltage side make their transmission lines wide. Thus, the resistance component of each transmission line is reduced, thereby suppressing the generation of the Joule heat. Moreover, the area of heat dissipation is increased, thereby enhancing the effect of the heat dissipation. Accordingly, the cooling mechanism can be simplified. Moreover, the coaxial capacitor formed from the housing on the ground side and the cylindrical member, and the coaxial capacitor formed from the transmission line on the higher voltage side and the cylindrical member, as well as the plate capacitor formed from the plate member and said another plate member are generally high in withstand voltage and therefore capable of securing a large amount of allowable current. Further, each of these capacitors is inexpensive for its simple structure and also hardly requires maintenance for its hard-to-break nature.

### BRIEF DESCRIPTION OF THE DRAWINGS

FIG. 1 is a circuit diagram showing the circuit configuration of an inductively coupled plasma generation device according to the present invention as an illustrative embodiment (Embodiment 1) thereof

FIG. 2 is a side view showing a schematic configuration of the inductively coupled plasma generation device according to the present invention as another illustrative embodiment (Embodiment 2) thereof

FIG. 3 is a top view of an antenna unit of the inductively coupled plasma generation device shown in FIG. 2.

FIG. 4 is a side view showing a schematic configuration of the inductively coupled plasma generation device according to the present invention as another illustrative embodiment (Embodiment 3) thereof

FIG. 5 is a top view of an antenna unit of the inductively coupled plasma generation device shown in FIG. 4.

FIG. 6 is a side view showing a schematic configuration of the inductively coupled plasma generation device according to the present invention as another illustrative embodiment (Embodiment 4) thereof

FIG. 7 is a top view of an antenna unit of the inductively coupled plasma generation device shown in FIG. 6.

FIG. 8 is a side view showing a schematic configuration of the inductively coupled plasma generation device according to the present invention as another illustrative embodiment (Embodiment 5) thereof

FIG. 9 is a top view of an antenna unit of the inductively coupled plasma generation device shown in FIG. 8.

FIG. 10 is a circuit diagram showing the circuit configuration of a conventional inductively coupled plasma generation device.

FIG. 11 is a set of diagrams each showing a Smith chart used for calculating impedance matching, in which Part (a) is a case corresponding to the circuit configuration shown in FIG. 10 while Part (b) is a case where coils L1 and L2 are excluded from the circuit configuration shown in FIG. 10.

### MODES FOR CARRYING OUT THE INVENTION

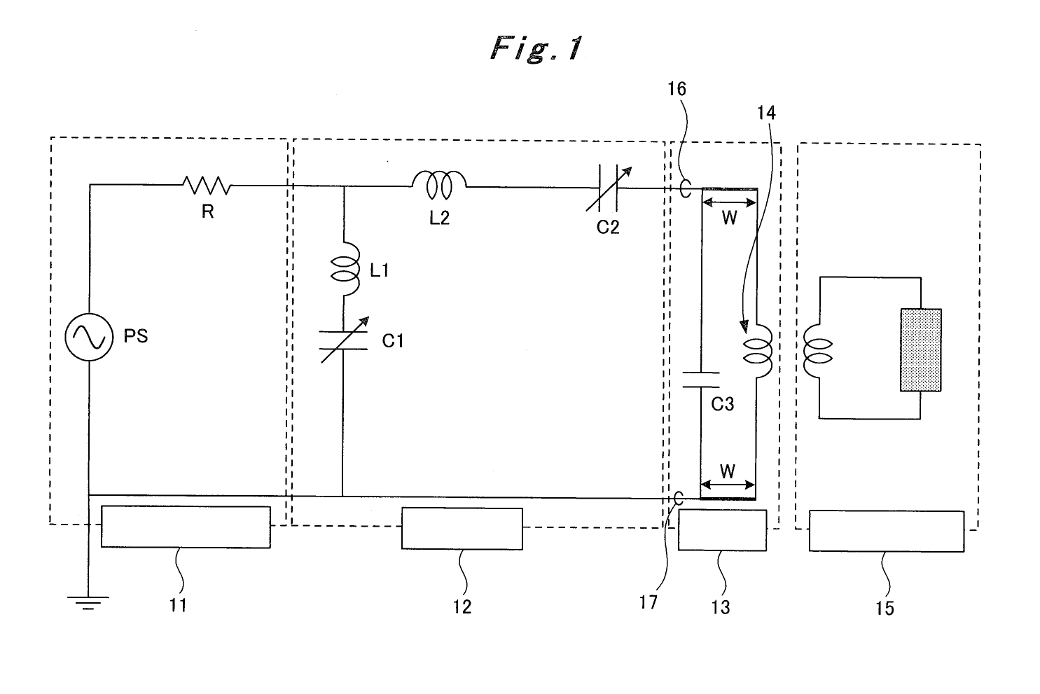

Hereinbelow, some embodiments of an inductively coupled plasma generation device according to the present invention will be described with reference to FIGS. 1 to 9. Note that the following embodiments will be described by assuming a plasma processing apparatus configured to fabricate a semiconductor device by performing plasma processing on a disk-shaped substrate (wafer) (for example, a plasma CVD apparatus, a plasma etching apparatus, or the like). However, the inductively coupled plasma generation device according to the present invention is applicable to any apparatuses as long as they are apparatuses configured to generate plasma. Moreover, the shape of an antenna used in the inductively coupled plasma generation device may be in any shape (for example, a rectangular ring shape or the like) as long as it is an inductive coupling type. In the following, the descriptions will be given by showing an antenna of a circular ring shape as an example.

### Embodiment 1

An inductively coupled plasma generation device of this embodiment is designed to be provided as a plasma source of a plasma processing apparatus (for example, a plasma CVD apparatus, a plasma etching apparatus, or the like). To describe a schematic configuration of the plasma processing apparatus, it includes, through not illustrated herein, a vacuum chamber which is controlled at a desired vacuum and supplied with a desired gas, a support table which supports a wafer in the vacuum chamber, the inductively coupled plasma generation device which generates plasma in the vacuum chamber, and the like.

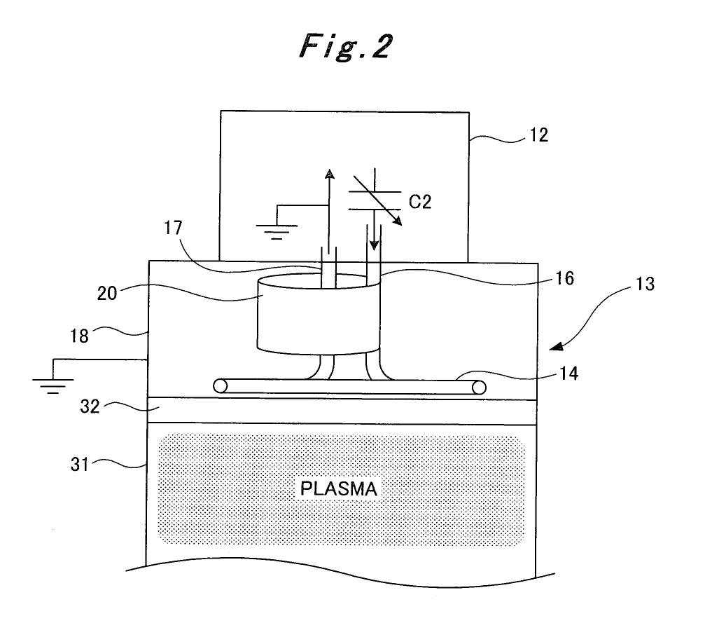

As shown in FIG. 2 mentioned later, the vacuum chamber includes a tubular container (reference numeral 31 in FIG. 2) and a top panel (reference numeral 32 in FIG. 2) tightly sealing the top of the tubular container. An antenna configured to supply an electromagnetic wave is disposed on top of the top panel. The inductively coupled plasma generation device is formed by connecting a high-frequency power source to the antenna through a matching box configured to perform impedance matching.

In the plasma processing apparatus configured as above, as a high frequency wave is supplied from the high-frequency power source, an electromagnetic wave is supplied from the antenna into the vacuum chamber through the top panel made of a dielectric material such as ceramic. The supplied electromagnetic wave then excites and ionizes the gas inside the vacuum chamber, thereby generating plasma. With the generated plasma, plasma processing is performed on the substrate.

Now, the circuit configuration of the inductively coupled plasma generation device of this embodiment will be described in detail with reference to a circuit diagram shown in FIG. 1.

The inductively coupled plasma generation device of this embodiment includes a high-frequency power source 11, a matching box 12, and an antenna unit 13. In the inductively coupled plasma generation device of this embodiment, the high-frequency power source 11 is represented as an RF power source PS (for example, a frequency of 13.56 MHz) and an internal resistance R (50Ω), and an antenna 14 of the antenna unit 13 is represented as a coil. The high-frequency power source 11 is connected to the antenna unit 13 through the matching box 12 having an L-type matching circuit. Specifically, in the matching box 12, a pre-set coil L1 and a variable capacitor C1, and a pre-set coil L2 and a variable capacitor C2 are disposed in an L shape.

With this configuration, an electromagnetic wave is supplied from the antenna 14 into the vacuum chamber to generate plasma in the vacuum chamber. A plasma load 15 of the generated plasma can be understood as transformer coupling having the antenna 14 as a primary winding and the plasma as a secondary winding formed of a coil and a resistance.

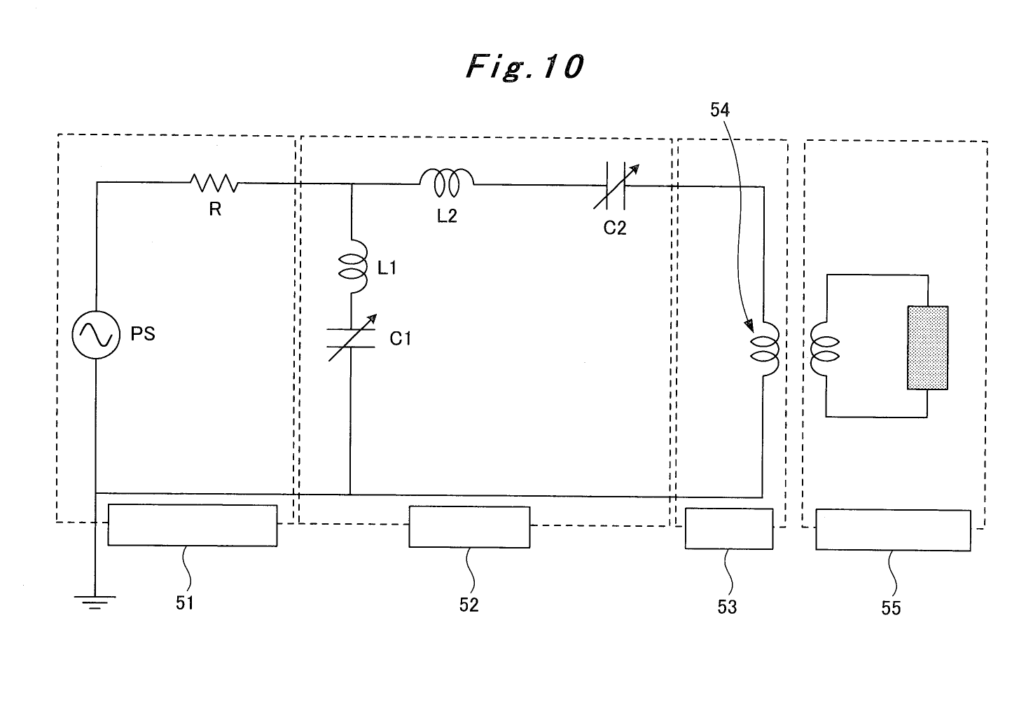

Thus, the inductively coupled plasma generation device of this embodiment has a configuration which is basically the same as that of the conventional inductively coupled plasma generation device shown in FIG. 10 but differs in that a fixed capacitor C3 (another capacitor) connected in parallel to the antenna 14 is added at a position closer to the antenna 14 than the capacitors C1 and C2 inside the matching box 12, that is, in the vicinity of the antenna 14. The fixed capacitor C3 may be a commercially available capacitor. To describe the position to dispose the fixed capacitor C3 with reference to FIG. 2 mentioned later, the position is preferably between a transmission line 16 provided between the capacitor C2 and the antenna 14, and a grounding line 17 grounding the antenna 14, and in the vicinity of the antenna 14, that is, in the periphery of a cylindrical member 20 described later.

In the circuit configuration shown in FIG. 1, the impedance of the plasma load 15 remains unchanged, so that the current flowing in the antenna 14 can be matched to that without the capacitor C3 being added. Thus, the current flowing in the antenna 14 is the total of the current from the capacitor C2 of the matching box 12 and the current from the added fixed capacitor C3. Accordingly, the amount of current from the capacitor C2 is reduced as compared to that without the fixed capacitor C3 being added. As a result, the amount of current flowing in the coil L2 connected in series to the capacitor C2 is also reduced. This reduces the generation of Joule heat in the coils L1 and L2 as well. Thereby, it is possible to suppress a loss in inputted power.

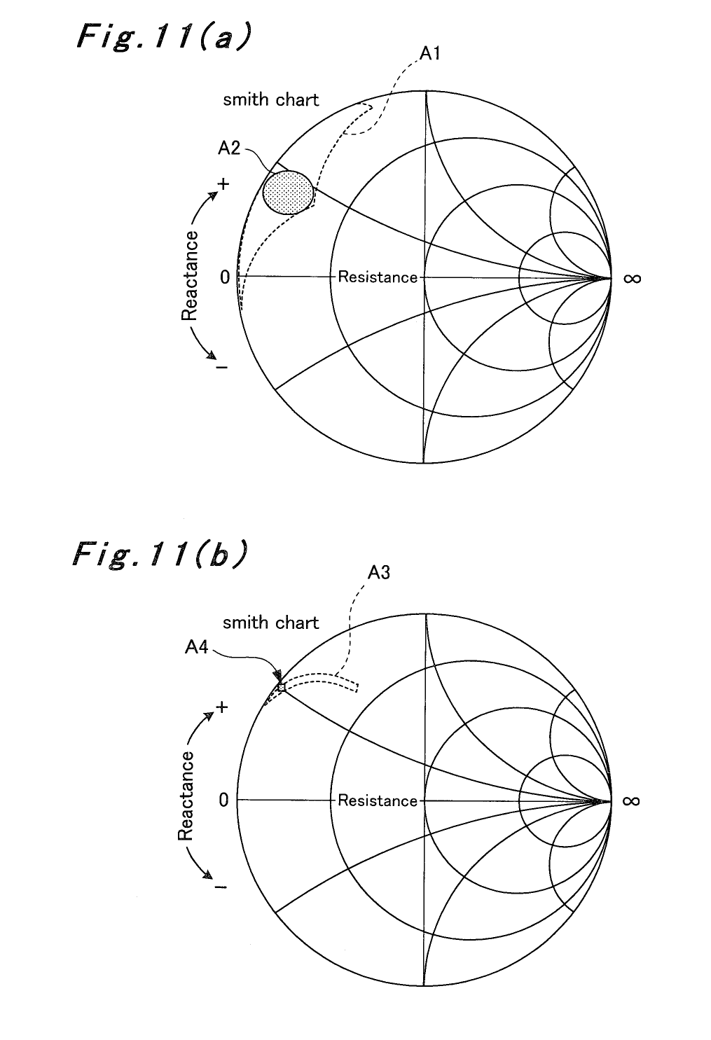

Note that the combination of the matching box 12 having an L-type matching circuit and the fixed capacitor C3 is commonly known as the π-type matching circuit in the field of electric circuit. However, since the capacitor C3 is not placed inside the matching box 12 but in the vicinity of the antenna 14 in this embodiment, the matching box 12 sees the antenna unit 13 including the capacitor C3 and the antenna 14 and the plasma load 15 as loads. For this reason, the matching range of the matching box 12 is sufficiently wide as described in Part (a) of FIG. 11 mentioned earlier. Accordingly, the matching box 12 can be used regardless of the antenna shape and the plasma processing conditions (such as the kind of gas and the pressure).

Moreover, since the capacitor C3 is in the vicinity of the antenna 14 in this embodiment, the length of a line W in each of the transmission line 16 and the grounding line 17 from the capacitor C3 to the antenna 14 (bold line portions in FIG. 1) is different from the that of a matching box 12 having a π-type matching circuit in which the capacitor C3 is inside the matching box; the length is clearly shorter in this embodiment (see FIG. 1). In the π-type matching circuit, when high current flows in portions corresponding to the lines W, a power loss due to the Joule heat occurs. In this embodiment, however, the power loss due to the Joule heat can be reduced because the lengths of the lines W are short.

As described, in the inductively coupled plasma generation device of this embodiment, the power loss due to the heat generation can be suppressed even when the matching box 12 having an L-type matching circuit has a wide matching range. In other words, it is possible to achieve both a wide matching range and a reduced power loss.

In addition, this embodiment further offers the following advantages as well.

First, since the amount of current in the matching box 12 is reduced, the voltage across both ends of each of the coil L2 and the capacitor C2 is lowered. As a result, when selecting the capacitor C2, one can select an inexpensive, small capacitor with low rated current and withstand voltage. Accordingly, it is possible to reduce the size and cost of the matching box 12. Moreover, while water cooling is often employed to cool down the coils L1 and L2, they can be cooled down via air cooling instead because the generation of the Joule heat is reduced, thereby allowing simplification of the structure of the matching box 12. Accordingly, it is possible to further reduce the cost thereof. Furthermore, the attachment of the commercially available capacitor C3 can be applied to conventional devices, and that modification is done easily.

### Embodiment 2

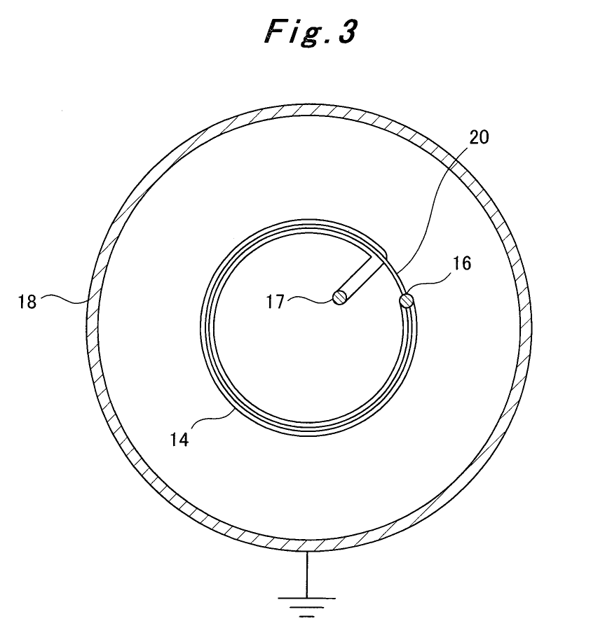

An inductively coupled plasma processing device of this embodiment is based on the circuit configuration of Embodiment 1 shown in FIG. 1 but differs from Embodiment 1 in that part of the transmission line 16 is worked to form a capacitor corresponding to the fixed capacitor C3, instead of using a commercially available capacitor as the fixed capacitor C3. Now, a schematic configuration of the inductively coupled plasma generation device of this embodiment will be described with reference to a side view shown in FIG. 2 and a top view shown in FIG. 3. Note that components similar to those in Embodiment 1 will be described with the same reference numerals being given thereto.

As described in Embodiment 1, there is a plasma processing apparatus with a vacuum chamber which includes a tubular container 31 and a top panel 32 of ceramic or the like tightly sealing the top of the tubular container 31. An antenna 14 of a circular ring shape configured to supply an electromagnetic wave is disposed on top of the top panel 32 along a flat surface of the top panel 32. The inductively coupled plasma generation device, which is configured to generate plasma in the vacuum chamber, is formed by connecting a high-frequency power source to the antenna 14 through a matching box 12. Moreover, by an electromagnetic wave supplied from the inductively coupled plasma generation device, plasma is generated in the vacuum chamber, and plasma processing is performed therewith on a substrate. Note that the plasma processing apparatus includes a support table configured to support a wafer inside the vacuum chamber, but the illustration of the support table is omitted in FIG. 2.

In this embodiment, the matching box 12 is disposed on top of an antenna unit 13 including the antenna 14. A transmission line 16 and a grounding line 17 connecting the matching box 12 and the antenna 14 are disposed standing vertically upward on the antenna 14. The antenna 14 is a circular ring formed in a substantially C shape, and the transmission line 16 and the grounding line 17 are connected to both end portions thereof, respectively. A housing 18 on the lateral side of the antenna unit 13 is formed in a cylindrical shape surrounding the periphery of the antenna 14 and is grounded.

Moreover, in this embodiment, a cylindrical member 20 is provided to part of the transmission line 16 on the higher voltage side standing vertically upward. The cylindrical member 20 is disposed coaxially with the housing 18 in a top view (see FIG. 3), and the circumference of the cylindrical member 20 is fixed at one point to the transmission line 16. In general, the antenna 14, the transmission line 16, and the grounding line 17 are formed of copper tubes. For this reason, the cylindrical member 20 is formed also of a copper plate or the like. In this way, when the cylindrical member 20 is fixed to the transmission line 16, the fixing may be done by a welding process such as brazing.

By providing the cylindrical member 20 to the transmission line 16 between a capacitor C2 and the antenna 14 as described, the cylindrical member 20 and the housing 18, which is grounded, serve respectively as one and the other electrodes of a capacitor with air therebetween. Accordingly, there is formed a coaxial capacitor (cylindrical capacitor) having a capacitance component between the housing 18 and the cylindrical member 20. Since the air inside the antenna unit 13 is air of a clean room environment at constant temperature and humidity, permittivity E of the air is stable. Thus, the configuration as above offers the same function as the fixed capacitor C3 shown in FIG. 1 and provides a replacement for the commercially available fixed capacitor. Referring to FIG. 1, the configuration is such that the coaxial capacitor is provided in parallel with the antenna 14 between the transmission line 16 and the grounding line 17 (=the housing 18) in FIG. 1.

When the cylindrical member 20 is provided, a certain distance d needs to be secured between the grounding line 17 and the housing 18 so as to prevent abnormal discharge between the grounding line 17 and the housing 18. When the maximum applied voltage is 10 kV, the distance d is desirably set to 37 mm or greater, as described in the standard IEC60950 (Table 2).

Moreover, length L of the cylindrical member 20 can be figured out from capacitance C which the coaxial capacitor requires as the fixed capacitor C3. Assume that the coaxial capacitor requires, for example, 100 pF as the fixed capacitor C3. In this case, if radius a of the housing 18 is 250 mm, radius b of the cylindrical member 20 is the difference between the radius a and the distance d, which is 213 mm. Then, by using a formula [C=2π∈L/ln(a/b)] for figuring out the capacitance of the coaxial capacitor, the length L may be calculated from 100 pF=(2×3.14×8.85×10⁻¹²×L)/ln(250×10⁻³/213×10⁻³), which leads to the length L≈0.29 m. Here, the permittivity ∈ of the air is substantially equal to vacuum permittivity ∈₀; for this reason, the vacuum permittivity ∈₀=8.85×10⁻¹² is used as the permittivity. Note that the above calculation is an example, and the length L can be figured out appropriately in accordance with conditions such as the desired applied voltage, the desired capacitance, and the size of the housing 18. Moreover, in the case of this embodiment, there occurs also capacitive coupling with the grounding line 17 inside the cylindrical member 20. Thus, this capacitance can also be added as a capacitor. However, this capacitance is small compared to the coaxial capacitor between the housing 18 and the cylindrical member 20 and is therefore not taken into consideration here.

In the inductively coupled plasma generation device of this embodiment, the capacitor C3 having a similar function to that of Embodiment 1 is formed by providing the cylindrical member 20 to the transmission line 16 to form the coaxial capacitor between the cylindrical member 20 and the housing 18 as described above. Accordingly, like Embodiment 1, the amount of current flowing in a coil L2 is reduced. This reduces the generation of Joule heat in coils L1 and L2 as well. Thereby, it is possible to suppress a loss in inputted power.

Moreover, in this embodiment, too, the capacitor C3 (coaxial capacitor) is not placed inside the matching box 12 but in the vicinity of the antenna 14. For this reason, the matching range of the matching box 12 is sufficiently wide as described in Part (a) of FIG. 11 mentioned earlier. Accordingly, the matching box 12 can be used regardless of the antenna shape and the plasma processing conditions (such as the kind of gas and the pressure).

Moreover, since the capacitor C3 (coaxial capacitor) is provided in the vicinity of the antenna 14, the length of a line W in each of the transmission line 16 and the grounding line 17 is short. Accordingly, the power loss due to the Joule heat can be reduced.

As described, in the inductively coupled plasma generation device of this embodiment, too, the power loss due to the heat generation can be suppressed even when the matching box 12 has a wide matching range. In other words, it is possible to achieve both a wide matching range and a reduced power loss.

In addition, this embodiment further offers the following advantages as well. Since the cylindrical member 20 is provided to the transmission line 16 on the higher voltage side in this embodiment, the transmission line 16 is practically wide. As a result, the resistance component of the transmission line 16 which high current flows through is reduced, thereby suppressing the generation of the Joule heat. Moreover, the area of heat dissipation is increased, thereby enhancing the effect of the heat dissipation. Accordingly, the cooling mechanism can be simplified. Moreover, the coaxial capacitor formed from the housing 18 and the cylindrical member 20 is generally higher in withstand voltage than commercially available capacitors and therefore capable of securing a larger amount of allowable current. Further, the coaxial capacitor is inexpensive for its simple structure and also hardly requires maintenance for its hard-to-break nature.

### Embodiment 3

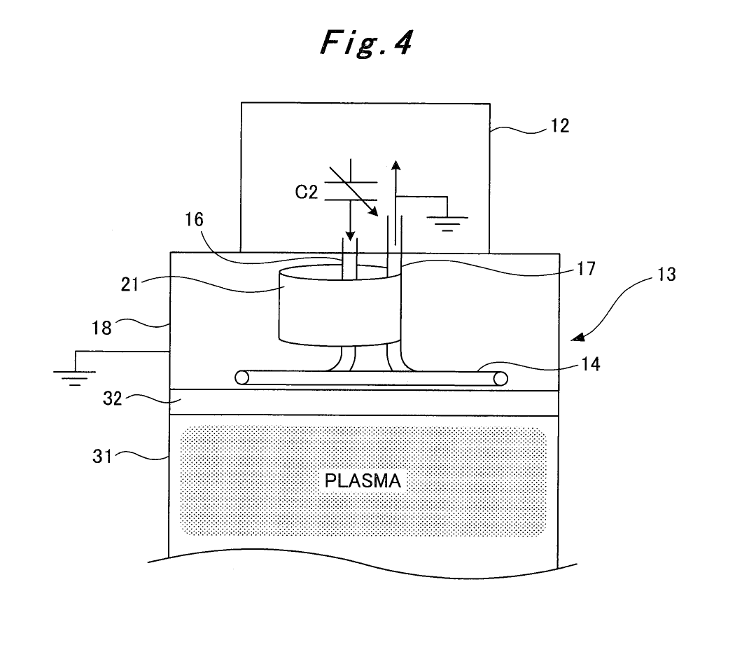

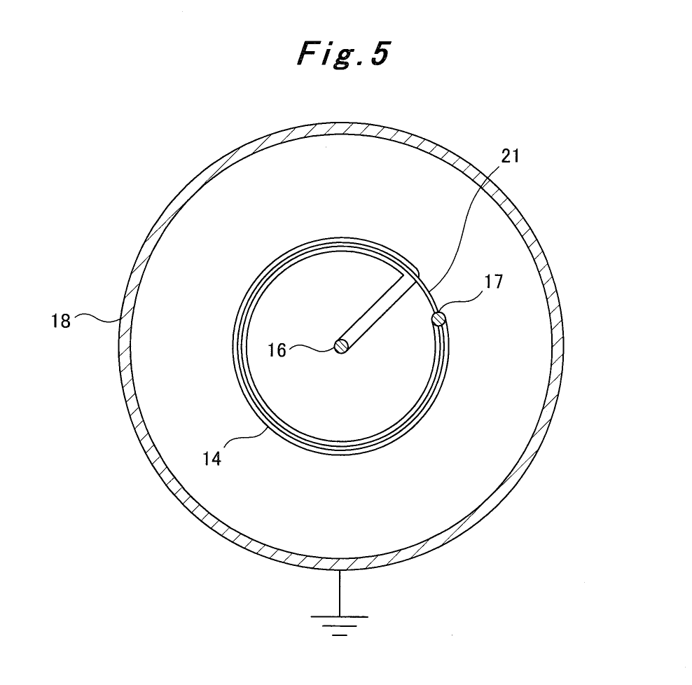

An inductively coupled plasma generation device of this embodiment is also based on the circuit configuration of Embodiment 1 shown in FIG. 1 but differs from Embodiment 1 in that part of the line is worked to form a capacitor corresponding to the fixed capacitor C3 like Embodiment 2, instead of using a commercially available capacitor as the fixed capacitor C3. Moreover, while part of the transmission line 16 is worked in Embodiment 2, this embodiment differs from Embodiment 2 in that part of the grounding line 17 is worked to form the capacitor corresponding to the fixed capacitor C3. Now, a schematic configuration of the inductively coupled plasma generation device of this embodiment will be described with reference to a side view shown in FIG. 4 and a top view shown in FIG. 5. Note that components similar to those in Embodiments 1 and 2 will be denoted by the same reference numerals and overlapping descriptions thereof will be omitted.

In this embodiment, too, like Embodiment 2, a matching box 12 is disposed on top of an antenna unit 13 including an antenna 14. A transmission line 16 and a grounding line 17 connecting the matching box 12 and the antenna 14 are disposed standing vertically upward on the antenna 14. The antenna 14 is a circular ring formed in a substantially C shape, and the transmission line 16 and the grounding line 17 are connected to both end portions thereof, respectively. A housing 18 on the lateral side of the antenna unit 13 is formed in a cylindrical shape surrounding the periphery of the antenna 14 and is grounded. Note that in this embodiment, the housing 18 may be neither in a cylindrical shape nor grounded.

Moreover, in this embodiment, a cylindrical member 21 is provided to part of the grounding line 17 standing vertically upward. The cylindrical member 21 is disposed with the center axis thereof being set on the transmission line 16 on the higher voltage side in a top view (see FIG. 5), and the circumference of the cylindrical member 21 is fixed at one point to the grounding line 17. The cylindrical member 21 is formed also of a copper plate or the like. Thus, when the cylindrical member 21 is fixed to the grounding line 17, the fixing may be done by a welding process such as brazing.

By providing the cylindrical member 21 to the grounding line 17 between a capacitor C2 and the antenna 14 as described, the cylindrical member 21 and the transmission line 16 serve respectively as one and the other electrodes of a capacitor with air therebetween. Accordingly, there is formed a coaxial capacitor (cylindrical capacitor) having a capacitance component between the transmission line 16 and the cylindrical member 21. The configuration as above offers the same function as the fixed capacitor C3 shown in FIG. 1 and provides a replacement for the commercially available fixed capacitor. Referring to FIG. 1, the configuration is such that the coaxial capacitor is provided in parallel with the antenna 14 between the transmission line 16 and the grounding line 17 in FIG. 1.

When the cylindrical member 21 is provided, a certain distance d needs to be secured between the cylindrical member 21 and the transmission line 16 so as to prevent abnormal discharge between the cylindrical member 21 and the transmission line 16. For example, when the maximum applied voltage is 10 kV, the distance d is desirably set to 37 mm or greater by referring to the standard IEC60950 (Table 2), as mentioned earlier.

Moreover, by using the calculation described in Embodiment 2, length L of the cylindrical member 21 can also be figured out appropriately in accordance with conditions such as the desired applied voltage and the desired capacitance. Note that when the desired capacitance is high, the diameter of the transmission line 16 may be increased, and/or a cylindrical member may be provided to the transmission line 16 itself. In addition to this, the diameter of the cylindrical member 21 may be increased as well.

In the inductively coupled plasma generation device of this embodiment, the capacitor C3 having a similar function to that of Embodiment 1 is formed by providing the cylindrical member 21 to the grounding line 17 to form the coaxial capacitor between the cylindrical member 21 and the transmission line 16 as described above. Accordingly, like Embodiment 1, the amount of current flowing in a coil L2 is reduced. This reduces the generation of Joule heat in coils L1 and L2 as well. Thereby, it is possible to suppress a loss in inputted power.

Moreover, in this embodiment, too, the capacitor C3 (coaxial capacitor) is not placed inside the matching box 12 but in the vicinity of the antenna 14. For this reason, the matching range of the matching box 12 is sufficiently wide as described in Part (a) of FIG. 11 mentioned earlier. Accordingly, the matching box 12 can be used regardless of the antenna shape and the plasma processing conditions (such as the kind of gas and the pressure).

Moreover, since the capacitor C3 (coaxial capacitor) is provided in the vicinity of the antenna 14, the length of a line W in each of the transmission line 16 and the grounding line 17 is short. Accordingly, the power loss due to the Joule heat can be reduced.

As described, in the inductively coupled plasma generation device of this embodiment, too, the power loss due to the heat generation can be suppressed even when the matching box 12 has a wide matching range. In other words, it is possible to achieve both a wide matching range and a reduced power loss.

In addition, this embodiment further offers the following advantages as well.

Since the cylindrical member 21 is provided to the grounding line 17 in this embodiment, the grounding line 17 is practically wide. As a result, the resistance component of the grounding line 17 which high current flows through is reduced, thereby suppressing the generation of the Joule heat. Moreover, the area of heat dissipation is increased, thereby enhancing the effect of the heat dissipation. Accordingly, the cooling mechanism can be simplified. Moreover, the coaxial capacitor formed from the transmission line 16 and the cylindrical member 21 is generally higher in withstand voltage than commercially available capacitors and therefore capable of securing a larger amount of allowable current. Further, the coaxial capacitor is inexpensive for its simple structure and also hardly requires maintenance for its hard-to-break nature.

### Embodiment 4

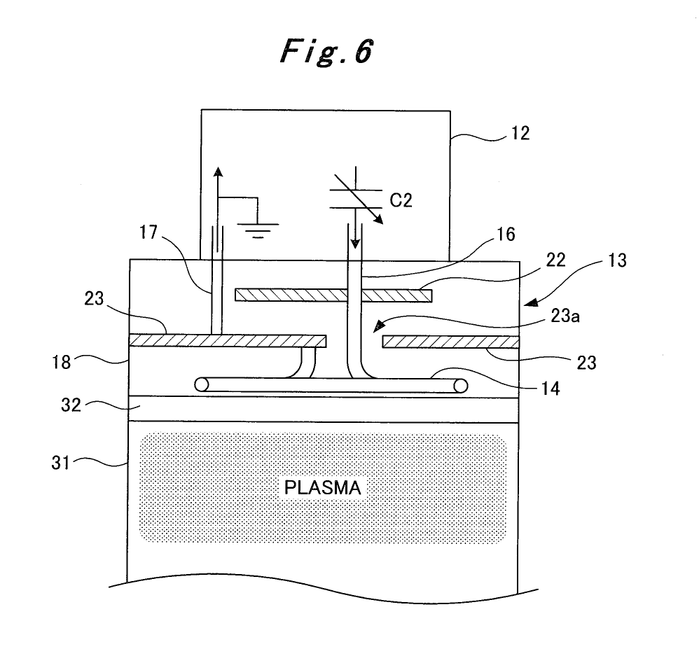

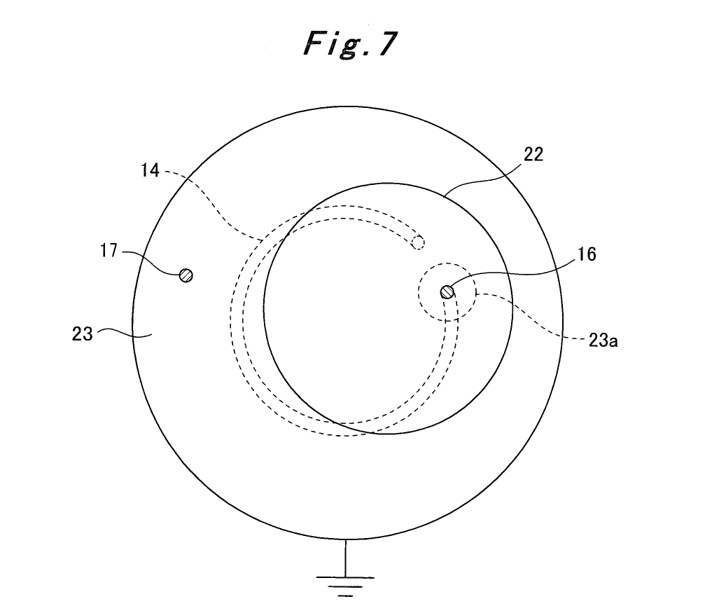

An inductively coupled plasma generation device of this embodiment is also based on the circuit configuration of Embodiment 1 shown in FIG. 1 but differs from Embodiment 1 in that part of each line is worked to form a capacitor corresponding to the fixed capacitor C3 like Embodiments 2 and 3, instead of using a commercially available capacitor as the fixed capacitor C3. Moreover, while a coaxial capacitor is formed as the fixed capacitor C3 in Embodiments 2 and 3, this embodiment differs from Embodiments 2 and 3 in that a plate capacitor is formed instead. In the following, a schematic configuration of the inductively coupled plasma generation device of this embodiment will be described with reference to a side view shown in FIG. 6 and a top view shown in FIG. 7. Note that components similar to those in Embodiments 1 to 3 will be denoted by the same reference numerals and overlapping descriptions thereof will be omitted.

In this embodiment, too, like Embodiments 2 and 3, a matching box 12 is disposed on top of an antenna unit 13 including an antenna 14. Moreover, the antenna 14 is a circular ring formed in a C shape as shown in FIG. 7. Furthermore, above the antenna 14, there is provided a circular grounding disk 23 (plate member) supported horizontally on the inner wall of a housing 18.

Moreover, a transmission line 16 connecting the higher voltage side of the matching box 12 and the antenna 14 is disposed connected to an end portion, on one side, of the antenna 14 and standing vertically upward through a through-hole 23a provided in the grounding disk 23. On the other hand, a grounding line 17 connecting the ground side of the matching box 12 and the antenna 14 is disposed standing vertically upward from the upper face of the grounding disk 23. An end portion, on the other side, of the antenna 14 is connected to the lower face of the grounding disk 23. In other words, provided is a configuration in which the grounding line 17 is provided with the grounding disk 23.

Moreover, in this embodiment, a disk member 22 (another plate member) is provided to part of the transmission line 16 standing vertically upward. The disk member 22 is disposed perpendicular to the transmission line 16 in such a way as to broaden horizontally and thus to be parallel to the grounding disk 23 in a side view (see FIG. 6). The disk member 22 is fixed at one point to the transmission line 16. The disk member 22 and the grounding disk 23 are each formed also of a copper plate or the like. Thus, when the disk member 22 and the grounding disk 23 are fixed to the transmission line 16 and the grounding line 17, the fixing may be done by a welding process such as brazing.

By providing the disk member 22 to the transmission line 16 between a capacitor C2 and the antenna 14 and providing the grounding disk 23 to the grounding line 17 as described, the disk member 22 and the grounding disk 23, which is grounded, serve respectively as one and the other electrodes of a capacitor with air therebetween. Accordingly, there is formed a plate capacitor having a capacitance component between the disk member 22 and the grounding disk 23. The configuration as above offers the same function as the fixed capacitor C3 shown in FIG. 1 and provides a replacement for the commercially available fixed capacitor. Referring to FIG. 1, the configuration is such that the plate capacitor is provided in parallel with the antenna 14 between the transmission line 16 and the grounding line 17 in FIG. 1.

When the disk member 22 is provided, a certain distance d needs to be secured between the disk member 22 and each of the grounding line 17, the housing 18, and the grounding disk 23 so as to prevent abnormal discharge between the disk member 22 and each of the grounding line 17, the housing 18, and the grounding disk 23. For example, when the maximum applied voltage is 10 kV, the distance d is desirably set to 37 mm or greater by referring to the standard IEC60950 (Table 2), as mentioned earlier.

Moreover, area S of the disk member 22 (the plate member with smaller electrode area) can be figured out from capacitance C which the plate capacitor requires as the fixed capacitor C3. Assume that the plate capacitor requires, for example, 100 pF as the fixed capacitor C3. In this case, by using a formula [C=∈×S/d] for figuring out the capacitance of the plate capacitor, the area S may be calculated from 100 pF=(8.85×10⁻¹²)×S/(37×10⁻³), which leads to the area S≈0.4 m². Here, vacuum permittivity ∈₀=8.85×10⁻¹² is likewise used as permittivity ∈ of air. Note that the above calculation is likewise an example, and the area S can be figured out appropriately in accordance with conditions such as the desired applied voltage and the desired capacitance.

In the inductively coupled plasma generation device of this embodiment, the capacitor C3 having a similar function to that of Embodiment 1 is formed by providing the disk member 22 and the grounding disk 23 respectively to the transmission line 16 and the grounding line 17 to form the plate capacitor between the disk member 22 and the grounding disk 23 as described above. Accordingly, like Embodiment 1, the amount of current flowing in a coil L2 is reduced. This reduces the generation of Joule heat in coils L1 and L2 as well. Thereby, it is possible to suppress a loss in inputted power.

Moreover, in this embodiment, too, the capacitor C3 (plate capacitor) is not placed inside the matching box 12 but in the vicinity of the antenna 14. For this reason, the matching range of the matching box 12 is sufficiently wide as described in Part (a) of FIG. 11 mentioned earlier. Accordingly, the matching box 12 can be used regardless of the antenna shape and the plasma processing conditions (such as the kind of gas and the pressure).

Moreover, since the capacitor C3 (plate capacitor) is provided in the vicinity of the antenna 14, the length of a line W in each of the transmission line 16 and the grounding line 17 is short. Accordingly, the power loss due to the Joule heat can be reduced.

As described, in the inductively coupled plasma generation device of this embodiment, too, the power loss due to the heat generation can be suppressed even when the matching box 12 has a wide matching range. In other words, it is possible to achieve both a wide matching range and a reduced power loss.

Moreover, since the disk member 22 is provided to the transmission line 16 on the higher voltage side and also the grounding disk 23 is provided to the grounding line 17 on the ground side in this embodiment, the transmission line 16 and the grounding line 17 are practically wide. As a result, the resistance component of each of the transmission line 16 and the grounding line 17 which high current flows through is reduced, thereby suppressing the generation of the Joule heat. Moreover, the area of heat dissipation is increased, thereby enhancing the effect of the heat dissipation. Accordingly, the cooling mechanism can be simplified. Moreover, the plate capacitor formed from the disk member 22 and the grounding disk 23 is generally higher in withstand voltage than commercially available capacitors and therefore capable of securing a larger amount of allowable current. Further, the plate capacitor is inexpensive for its simple structure and also hardly requires maintenance for its hard-to-break nature.

### Embodiment 5

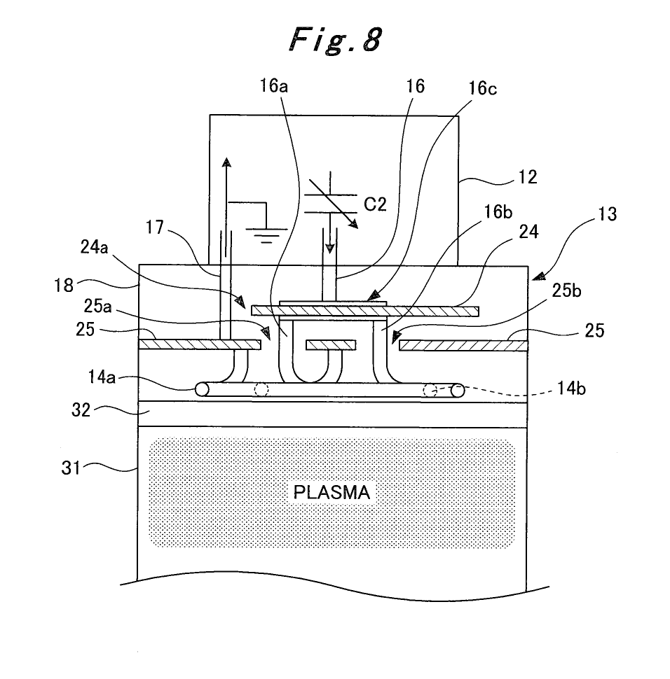

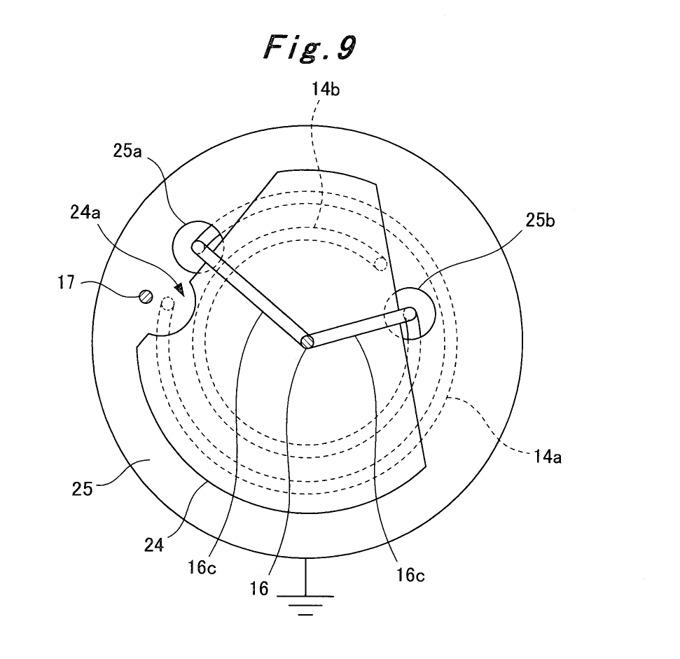

An inductively coupled plasma generation device of this embodiment is also based on the circuit configuration of Embodiment 1 shown in FIG. 1 but differs from Embodiment 1 in that part of each line is worked to form a capacitor corresponding to the fixed capacitor C3 like Embodiments 2 to 4, instead of using a commercially available capacitor as the fixed capacitor C3. Moreover, while a coaxial capacitor is formed as the fixed capacitor C3 in Embodiments 2 and 3, this embodiment differs from Embodiments 2 and 3 in that a plate capacitor is formed like Embodiment 4. Furthermore, this embodiment differs from Embodiment 4 in that there are multiple antennae. In the following, a schematic configuration of the inductively coupled plasma generation device of this embodiment will be described with reference to a side view shown in FIG. 8 and a top view shown in FIG. 9. Note that components similar to those in Embodiments 1 to 4 will be denoted by the same reference numerals and overlapping descriptions thereof will be omitted.

In this embodiment, too, like Embodiments 2 to 4, a matching box 12 is disposed on top of an antenna unit 13 including antennae 14. However, as the antennae, two antennae 14a and 14b of different sizes are electrically connected to each other in parallel and disposed concentric to each other on the same plane. As shown in FIG. 8, each of the antennae 14a and 14b is a circular ring formed in a C shape. Moreover, above the antennae 14a and 14b, there is provided a circular grounding disk 25 (plate member) supported horizontally on the inner wall of a housing 18.

Moreover, transmission lines 16a and 16b which are connected to end portions, on one side, of the antennae 14a and 14b are disposed standing vertically upward through through-holes 25a and 25b provided in a grounding disk 25, respectively. Each of the transmission lines 16a and 16b is connected to a transmission line 16 coming from the higher voltage side of the matching box 12 by a connecting line 16c disposed horizontally. With the line configuration as above, a capacitor C2 of the matching box 12 and the antennae 14 are connected to each other. On the other hand, a grounding line 17 connecting the ground side of the matching box 12 and the antennae 14 is disposed standing vertically upward from the upper face of the grounding disk 25. End portions, on the other side, of the antennae 14a and 14b are each connected to the lower face of the grounding disk 25. In other words, provided is a configuration in which the grounding line 17 is provided with the grounding disk 25.

Moreover, in this embodiment, too, a plate member 24 (another plate member) is provided to part of the transmission line 16. Here, by utilizing the horizontally disposed connecting line 16c, the plate member 24 is formed broadening horizontally from the connecting line 16c. The plate member 24 is disposed on the same plane as the longitudinal direction of the connecting line 16c so as to be parallel to the grounding disk 25 (perpendicular to the transmission line 16) in a side view (see FIG. 8). The plate member 24 is fixed to the connecting line 16c. The plate member 24 and the grounding disk 25 are each formed also of a copper plate or the like. Thus, when the plate member 24 and the grounding disk 25 are fixed to the connecting line 16c and the grounding line 17, the fixing may be done by a welding process such as brazing.

By providing the plate member 24 to the connecting line 16c between the capacitor C2 and the antennae 14 and providing the grounding disk 25 to the grounding line 17 as described, the plate member 24 and the grounding disk 25, which is grounded, serve respectively as one and the other electrodes of a capacitor with air therebetween. Accordingly, there is formed a plate capacitor having a capacitance component between the plate member 24 and the grounding disk 25. The configuration as above offers the same function as the fixed capacitor C3 shown in FIG. 1 and provides a replacement for the commercially available fixed capacitor. Referring to FIG. 1, the configuration is such that the plate capacitor is provided in parallel with the antennae 14 between the transmission line 16 and the grounding line 17 in FIG. 1.

When the plate member 24 is provided, a certain distance d needs to be secured between the plate member 24 and each of the grounding line 17, the housing 18, and the grounding disk 25 so as to prevent abnormal discharge between the plate member 24 and each of the grounding line 17, the housing 18, and the grounding disk 25. In this embodiment, for example, a recess 24a is provided in the plate member 24 as shown in FIG. 9 so as to secure a distance to the grounding line 17. For example, when the maximum applied voltage is 10 kV, the distance d is desirably set to 37 mm or greater by referring to the standard IEC60950 (Table 2), as mentioned earlier. Moreover, area S of the plate member 24 (the plate member with smaller electrode area) can be figured out appropriately in accordance with conditions such as the desired applied voltage and the desired capacitance by using the calculation described in Embodiment 4.

In the inductively coupled plasma generation device of this embodiment, too, the capacitor C3 having a similar function to that of Embodiment 1 is formed by providing the plate member 24 and the grounding disk 25 respectively to the transmission line 16 (connecting line 16c) and the grounding line 17 to form the plate capacitor between the plate member 24 and the grounding disk 25 as described above. Accordingly, like Embodiment 1, the amount of current flowing in a coil L2 is reduced. This reduces the generation of Joule heat in coils L1 and L2 as well. Thereby, it is possible to suppress a loss in inputted power.

Moreover, in this embodiment, too, the capacitor C3 (plate capacitor) is not placed inside the matching box 12 but in the vicinity of the antennae 14. For this reason, the matching range of the matching box 12 is sufficiently wide as described in Part (a) of FIG. 11 mentioned earlier. Accordingly, the matching box 12 can be used regardless of the antenna shape and the plasma processing conditions (such as the kind of gas and the pressure).

Moreover, since the capacitor C3 (plate capacitor) is provided in the vicinity of the antennae 14, the length of a line W in each of the transmission line 16 and the grounding line 17 is short. Accordingly, the power loss due to the Joule heat can be reduced.

As described, in the inductively coupled plasma generation device of this embodiment, too, the power loss due to the heat generation can be suppressed even when the matching box 12 has a wide matching range. In other words, it is possible to achieve both a wide matching range and a reduced power loss.

Moreover, like Embodiment 4, since the plate member 24 is provided to the transmission line 16 on the higher voltage side and also the grounding disk 25 is provided to the grounding line 17 on the ground side in this embodiment, the transmission line 16 and the grounding line 17 are practically wide. As a result, the resistance component of each of the transmission line 16 and the grounding line 17 which high current flows through is reduced, thereby suppressing the generation of the Joule heat. Moreover, the area of heat dissipation is increased, thereby enhancing the effect of the heat dissipation. Accordingly, the cooling mechanism can be simplified. Moreover, the plate capacitor formed from the plate member 24 and the grounding disk 25 is generally higher in withstand voltage than commercially available capacitors and therefore capable of securing a larger amount of allowable current. Further, the plate capacitor is inexpensive for its simple structure and also hardly requires maintenance for its hard-to-break nature.

### INDUSTRIAL APPLICABILITY

The inductively coupled plasma processing device according to the present invention is suitable particularly for plasma processing apparatuses used for semiconductor device fabrication (such as plasma CVD apparatuses and plasma etching apparatuses).

### REFERENCE SIGNS LIST

11 high-frequency power source
12 matching box
13 antenna unit
14, 14a, 14b antenna
16 transmission line
17 grounding line
18 housing
20, 21 cylindrical member
22 disk member (another plate member)
23 grounding disk (plate member)
24 plate member (another plate member)
25 grounding disk (plate member)
C3 fixed capacitor (another capacitor)

1. An inductively coupled plasma generation device for generating plasma in a vacuum chamber by use of an electromagnetic wave from an antenna obtained by supplying a high-frequency wave from a high-frequency power source to the antenna through a matching box configured to perform impedance matching, wherein
an L-type matching circuit is used as the matching box, and
another capacitor is provided parallel to the antenna at a position closer to the antenna than capacitors in the L-type matching circuit.

2. The inductively coupled plasma generation device according to claim 1, wherein a commercially available capacitor is used as said another capacitor.

3. The inductively coupled plasma generation device according to claim 1, wherein
a circumference of the antenna is surrounded by a grounded cylindrical housing while a cylindrical member coaxial with the housing is provided to a transmission line on a higher voltage side connected to the antenna, to thereby form a coaxial capacitor with the housing and the cylindrical member, and
the coaxial capacitor is used as said another capacitor.

4. The inductively coupled plasma generation device according to claim 1, wherein
a cylindrical member with a center axis thereof being set on a transmission line on a higher voltage side connected to the antenna is provided to a transmission line on a ground side connected to the antenna, to thereby form a coaxial capacitor with the transmission line on the higher voltage side and the cylindrical member, and
the coaxial capacitor is used as said another capacitor.

5. The inductively coupled plasma generation device according to claim 1, wherein
a grounded plate member is provided above the antenna while another plate member parallel to the plate member is provided to a transmission line on a higher voltage side connected to the antenna, to thereby form a plate capacitor with the plate member and said another plate member, and
the plate capacitor is used as said another capacitor.

6. The inductively coupled plasma generation device according to claim 5, wherein
the antenna is formed of a plurality of antennae of different sizes connected to each other in parallel, and
the plurality of antennae are disposed concentric to each other on a same plane.
